(19) United States
(12) Patent Application Publication
(10) Pub. No.: US 2006/0112024 A1
(43) Pub. Date: May 25, 2006

(54) Use of machine readable code to print the return address

(76) Inventors: Russell Wadd, Melton Mowbray (GB); David Glover, Pershore (GB); Richard Rosen, Trumball, CT (US); Dennis Gilham, Essex (GB)

Correspondence Address: Geza C. Ziegler, Jr.;Perman & Green, LLP, 425 Post Road, Fairfield, CT, 06824, US

(21) Appl. No.: 10/993,021

(22) Filed: Nov. 19, 2004

(51) Int. Cl. G06F 17/00

(52) U.S. Cl. 705/410

(57) ABSTRACT

A system for returning a mailpiece to a sender without a human readable return address on the mailpiece. The system includes a device adapted to generate a machine-readable code to be printed on the mailpiece. The machine-readable code includes a return address for the sender. A scanning device is used to interpret the machine-readable code when it is determined that the mailpiece is to be returned to the sender. A printing device can receive instructions from the scanning device to print the return address in a human readable form for return of the mailpiece to the sender.

### BACKGROUND OF THE INVENTION

1. Field of the Invention

The present invention generally relates to mail processing and in particular to the use of machine readable code to print a return address.

2. Brief Description of Related Developments

Many mailers or senders of a mailpiece prefer to create mail without providing a return address on the outside of an envelope or package. Because of this, when mail is undeliverable, a postal or mail delivery service, such as for example the Royal Mail Service or the United States Postal Service (“USPS”), must manually open and examine the piece in order to return the mail to the originator. This is a major expense for the mail delivery service.

For mail that is metered (franked), the Post can use the postage meter indicia to identify the sender. This however requires the Post to search a database to match the meter number to a database, which is cumbersome, time consuming and inconvenient.

Since mailers are leaving the return address off an envelope or parcel for reasons of privacy, security or personal preferences, the Post cannot, and does not want to force the mailer to include a return address.

It would be advantageous to be able to include a return address on a mailpiece in a secure and confidential manner.

### SUMMARY OF THE INVENTION

The present invention is directed to a system for returning a mailpiece to a sender without a human readable return address on the mailpiece. In one embodiment the system comprises a device adapted to generate a machine-readable code to be printed on the mailpiece. The machine-readable code includes a return address for the sender. A scanning device is used to interpret the machine-readable code when it is determined that the mailpiece is to be returned to the sender. A printing device can receive instructions from the scanning device to print the return address in a human readable form for return of the mailpiece to the sender.

In another aspect, the present invention is directed to a method for processing a mailpiece without a human readable return address on the mailpiece. In one embodiment the method comprises reading a coded identifier that is not human readable and is printed on the mailpiece, the coded identifier including information related to a return address for the mailpiece. A human readable destination address is generated from the coded identifier that provides the return address in human readable form. Using the generated address, the mailpiece is returned to the sender.

In a further aspect, the present invention is directed to a computer program product. In one embodiment the computer program product comprises a computer useable medium having computer readable code means embodied therein for causing a computer to process a mailpiece without a human readable return address on the mailpiece. The computer readable code means in the computer program product comprises computer readable program code means for causing a computer to generate a coded identifier that is not human readable and is printed on the mailpiece, the coded identifier including information related to a return address for the mailpiece, to determine that the mailpiece is to be returned to sender, read the coded identifier and generate a human readable destination address from the coded identifier that provides the return address in human readable form, and arrange for the return of the mailpiece to the sender.

In yet another aspect, the present invention is directed to an article of manufacture. In one embodiment the article of manufacture comprises a computer useable medium having computer readable program code means embodied therein for causing a computer to process a mailpiece. The computer readable code means in the article of manufacture comprises computer readable program code means for causing a computer to generate a machine readable code to be printed on the mailpiece, the machine readable code comprising a return address for the sender, interpret the machine readable code when it is determined that the mailpiece is to be returned to the sender, and print the return address in a human readable form for return of the mailpiece to the sender.

### BRIEF DESCRIPTION OF THE DRAWINGS

The foregoing aspects and other features of the present invention are explained in the following description, taken in connection with the accompanying drawings, wherein:

FIG. 1 is an illustration of one embodiment of a mailpiece incorporating features of the present invention.

FIG. 2 is a block diagram of one embodiment of a system that can be used to practice the present invention.

FIGS. 3A-3C illustrates a flowchart of one embodiment of a method incorporating features of the present invention.

FIG. 4 is a block diagram of one embodiment of an apparatus that can be used to practice the present invention.

### DETAILED DESCRIPTION OF THE PREFERRED EMBODIMENT(s)

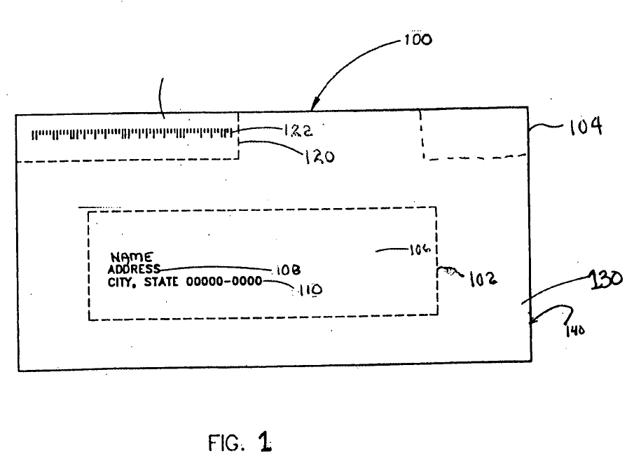

Referring to FIG. 1, an illustration of one embodiment of a mailpiece 100 incorporating features of the present invention is shown. Although the present invention will be described with reference to the embodiment shown in the drawings, it should be understood that the present invention can be embodied in many alternate forms of embodiments. In addition, any suitable size, shape or type of elements or materials could be used.

As shown in FIG. 1, a typical mailpiece, such as an envelope 100 generally includes a delivery address field 102, and a postage indicia field 104. At least these two fields are typically required for delivery of the mailpiece 100. As shown in FIG. 1, the envelope 100 does not include any readily human readable or viewable information identifying or indicating who is mailing, sending, or responsible for the content of, the envelope (the “mailer”) to the delivery address 102. The delivery address field can include a name field 106, and street field 108 and a city/state field 110, for example. A return address field 120 can also be included on the mailpiece. Although it might be possible to include a return address section, there is no guarantee that a “mailer” as the term is used herein, would fill it in with information identifying an origin of the mailpiece. This is particularly true if the mailer wants to remain anonymous.

The mailpiece 100 in FIG. 1 includes a machine readable code 122 in the field 120 that includes information identifying the mailer, a location of the mailer, or a destination for a return of the mailpiece 100. Although the code 122 is shown being located in the return address field 120 on the mailpiece of FIG. 1, it will be understood that the code 122 can be located in any suitable location on the mailpiece 100, including the front 130 or back side 140 of the mailpiece. It is a feature of the present invention to include a machine readable return address printed anywhere on the envelope, for example in the address field, return address field or the meter add field.

The machine readable code 122 is shown in FIG. 1 as being a bar code. In alternate embodiments, the code 122 can comprise any suitable code, including for example, a data matrix, PDF or any two-dimensional code.

Current meters (franking machines) and digital printers are capable of printing information in machine-readable form that cannot be read by people without the use of scanning or other specialized equipment. A standard address printer or the postage meter can also print the machine-readable code.

At the time the address is printed or at the time the meter indicia is printed, a machine-readable code that includes information identifying the mailer will be printed. In alternate embodiment, the information identifying the mailer could be pre-printed on the mailpiece. This machine-readable code can be a two or three dimensional bar code for example, which when scanned by the Post, would show the address of the mailer. Although the use of a bar code is described herein, any suitable coding scheme can be used. This would allow the Post to identify the mailer without having to open the mail or parcel to identify the mailer, saving it significant costs.

If non-repudiation for the return address is required, then a secure code could be generated and included with the return address information in the machine readable code. Alternatively, if a secure meter imprint is applied at the same time as the return address code the validation code included in the postage imprint could be used to verify the correct return address. For example, the address machine readable code could contain the last two digits of the postage validation code that changes on each mail item for cross check or a more comprehensive derived code can be used. Security associated with the return address may be required to avoid errors as well as mischievous actions from an unknown party.

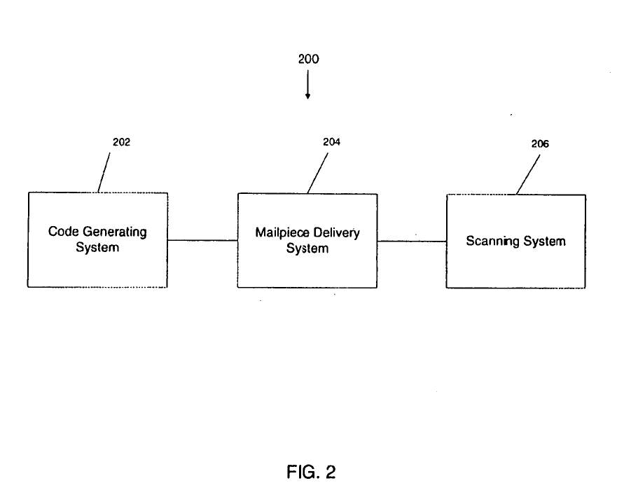

One example of a system 200 incorporating features of the present invention is illustrated in FIG. 2. A code-generating device 202 can be used to receive the information related to the mailer of the mailpiece and generate a suitable code including the information. The code can then be printed on the mailpiece, or alternatively a label for the mailpiece, and the mailpiece deposited with or entered in the postal or other delivery system 204. In the event the mailpiece is indicated as to be returned to sender, a scanning device 206 interprets the code on the mailpiece and generates a return address in human readable form. The mailpiece can then be returned to sender.

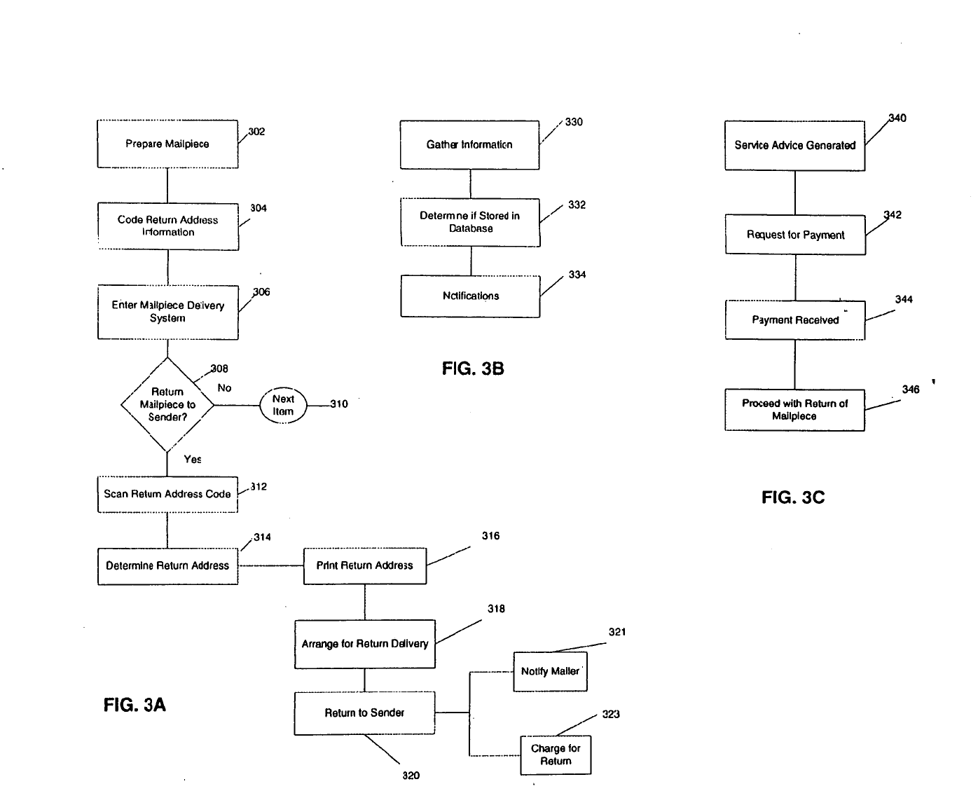

Referring to FIG. 3A, one embodiment of a method incorporating features of the present invention is illustrated. When an envelope or other mailpiece is prepared 302 for mailing, a machine readable code incorporating the return address of the mailpiece is printed 304 onto the mailpiece. The printing could be directly on the mailpiece, such as for example an envelope, or on a label for the mailpiece.

The machine readable code could also include security checking or authentication means. The mailpiece is then entered 306 into the mail processing system, which could include delivery to a postal authority. At some point during the mail delivery process, it is determined 308 whether or not the mailpiece is to be returned to the original sender. If not, the system moves on to evaluate 310 the next item. If it is to be returned, the mailpiece is returned to the postal authority station, which could be the last post office that handled the mailpiece. Since the mailpiece does not have a human readable return address, the machine readable code for the return address is scanned 312. Once scanned, the address can be deciphered 314 and printed 316 either directly on the mailpiece or on a label to be attached to the mailpiece. The mailpiece can then continue to be processed to arrange for the return 318 and delivered or returned 320 to the original sender. In one embodiment, the return process could include notifying 321 the original mailer of the mailpiece that the mailpiece is being returned as well as charging 323 the mailer for the return.

In one embodiment referring to FIG. 3B, the return action shown in FIG. 3A, including the scanning 310 through delivery 318, can be linked to a remote database that facilitates notifying the sender in advance that the mailpiece is being returned. In this embodiment, the return address information together with the original delivery information gathered from the address block 102 is provided 330 to the database. If notification information is stored 332 in the database, the sender can be notified 334 that the mailpiece is being returned. The notification 334 could include for example an online notification via electronic mail. Alternatively, the database could include instructions for returning a mailpiece or notifying the sender that may differ from returning the mailpiece directly to the sender or notifying the sender. In this case, the instructions could be provided to the postal system and the mailpiece processed accordingly.

Referring to FIG. 3C, the return action 310-318 of FIG. 3A could also be linked to a charging system that allows and facilitates the operator of the mail or post service to charge for the return mail service. When the mailpiece is arranged 316 for return, a service advice can be generated 340 that requests 342 payment from the sender or authorized financial center for the return. The service advice can determine the appropriate charges for the return based on the current location of the mailpiece and the return information deciphered from the mailpiece. Once payment is received 344, the return of the mailpiece to the sender can proceed 346.

The message received by the sender as part of the notification could be a file including the intended recipients name and address, the reason for non-delivery, and details of the date of mailing obtained from the postage imprint or indicia.

In one embodiment, the intended recipient's name and details could be validated against a database of customer preset conditions to see whether the item should be returned, redirected or destroyed, for example, if the mailpiece is not deliverable. The sender may not desire to have certain mail returned if not deliverable, in which case it could be destroyed or disposed of in accordance with predetermined procedures.

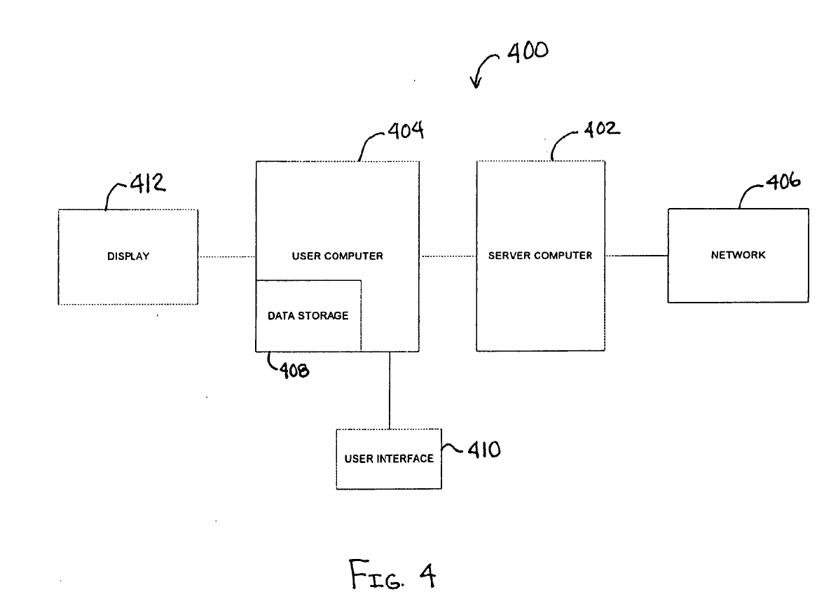

The present invention may also include software and computer programs incorporating the process steps and instructions described above that are executed in different computers. In the preferred embodiment, the computers are connected to the Internet. FIG. 4 is a block diagram of one embodiment of a typical apparatus 400 incorporating features of the present invention that may be used to practice the present invention. As shown, a computer system 402 may be linked to another computer system 404, such that the computers 402 and 404 are capable of sending information to each other and receiving information from each other. In one embodiment, computer system 402 could include a server computer adapted to communicate with a network 406, such as for example, the Internet. Computer systems 402 and 404 can be linked together in any conventional manner including a modem, wireless or hard wire connection, or fiber optic link. Generally, information can be made available to both computer systems 402 and 404 using a communication protocol typically sent over a communication channel or through a dial-up connection on ISDN line. Computers 402 and 404 are generally adapted to utilize program storage devices embodying machine readable program source code which is adapted to cause the computers 402 and 404 to perform the method steps of the present invention. The program storage devices incorporating features of the present invention may be devised, made and used as a component of a machine utilizing optics, magnetic properties and/or electronics to perform the procedures and methods of the present invention. In alternate embodiments, the program storage devices may include magnetic media such as a diskette or computer hard drive, which is readable and executable by a computer. In other alternate embodiments, the program storage devices could include optical disks, read-only-memory (“ROM”) floppy disks and semiconductor materials and chips.

Computer systems 402 and 404 may also include a microprocessor for executing stored programs. Computer 404 may include a data storage device 408 on its program storage device for the storage of information and data. Data could also be stored on an external system (not shown). The computer program or software incorporating the processes and method steps incorporating features of the present invention may be stored in one or more computers 402 and 404 on an otherwise conventional program storage device. In one embodiment, computers 402 and 404 may include a user interface 410, and a display interface 412 from which features of the present invention can be accessed. The display interface could also be an external printer or system. The user interface 410 and the display interface 412 can be adapted to allow the input of queries and commands to the system, as well as present the results of the commands and queries.

It should be understood that the foregoing description is only illustrative of the invention. Various alternatives and modifications can be devised by those skilled in the art without departing from the invention. Accordingly, the present invention is intended to embrace all such alternatives, modifications and variances which fall within the scope of the appended claims.

1. A system for processing a mailpiece comprising:
a device adapted to generate a machine readable code to be printed on the mailpiece, the machine readable code comprising a return address for the sender;
a scanning device adapted to interpret the machine readable code when it is determined that the mailpiece is to be returned to the sender; and
a printing device adapted to receive instructions from the scanning device to print the return address in a human readable form for return of the mailpiece to the sender.

2. The system of claim 1 further comprising a remote database linked to the scanning device that provides a link to the sender, wherein when the machine readable code is scanned for a return to sender mailpiece, the remote database is automatically searched for the sender and notification is provided to the sender that the mailpiece is being returned.

3. The system of claim 1 further comprising a fee charging system linked to the scanning device that automatically charges a fee to the sender for return of the mailpiece.

4. The system of claim 1 further comprising a secure code generator linked to the machine readable code device adapted to generate a secure machine readable code return address.

5. The system of claim 1 further comprising a postal security device linked to the printing device, the postal security indicia adapted to provide a secure indicia for the mailpiece and provide the printing device with at least a portion of a secure indicia code that is combined with the machine readable code for the return address to link the secure indicia with the return address.

6. A method for processing a mailpiece without a human readable return address on the mailpiece comprising:
reading a coded identifier that is not human readable and is printed on the mailpiece, the coded identifier including information related to a return address for the mailpiece;
generating a human readable destination address from the coded identifier that provides the return address in human readable form; and
returning the mailpiece to the sender.

7. The method of claim 6 further comprising, during the reading of the coded identifier, comparing information contained in the coded identifier with information in a database, the information in the database including instructions on processing a return to sender mailpiece that are unique to a sender of the mailpiece.

8. The method of claim 6 further comprising, after the reading of the coded identifier, automatically electronically notifying a sender of the mailpiece that the mailpiece is identified as a return to send mailpiece.

10. The method of claim 6 further comprising, after reading the coded identifier, automatically charging a financial account of the sender for charges related to a return of the mailpiece to the sender.

11. The method of claim 6 wherein the reading of the coded identifier further comprises generating a return to sender mailing label for the mailpiece that includes an address of the sender derived from the coded information on the mailpiece.

12. A computer program product comprising:
a computer useable medium having computer readable code means embodied therein for causing a computer to process a mailpiece without a human readable return address on the mailpiece, the computer readable code means in the computer program product comprising:
computer readable program code means for causing a computer to generate a coded identifier that is not human readable and is printed on the mailpiece, the coded identifier including information related to a return address for the mailpiece;
computer readable program code means for causing a computer to determine that the mailpiece is to be returned to sender;
computer readable program code means for causing a computer to read the coded identifier and generate a human readable destination address from the coded identifier that provides the return address in human readable form; and
computer readable program code means for causing a computer to arrange for the return of the mailpiece to the sender.

13. The computer program product of claim 12 further comprising computer readable program code means for causing a computer to compare information contained in the coded identifier with information in a database, the information in the database including instructions on processing a return to sender mailpiece that are unique to a sender of the mailpiece.

14. The computer program product of claim 12 further comprising computer readable program code means for causing a computer to automatically electronically notify a sender of the mailpiece that the mailpiece is identified as a return to send mailpiece.

15. The computer program product of claim 12 further comprising computer readable program code means for causing a computer to automatically charge a financial account of the sender for charges related to a return of the mailpiece to the sender.

16. The computer program product of claim 12 further comprising computer readable program code means for causing a computer to generate a return to sender mailing label for the mailpiece that includes an address of the sender derived from the coded information on the mailpiece.

17. An article of manufacture comprising:
a computer useable medium having computer readable program code means embodied therein for causing a computer to process a mailpiece, the computer readable code means in the article of manufacture comprising:
computer readable program code means for causing a computer to generate a machine readable code to be printed on the mailpiece, the machine readable code comprising a return address for the sender;
computer readable program code means for causing a computer to interpret the machine readable code when it is determined that the mailpiece is to be returned to the sender; and
computer readable program code means for causing a computer to print the return address in a human readable form for return of the mailpiece to the sender.
